(19) United States
(12) Patent Application Publication
(10) Pub. No.: US 2025/0138976 A1
(43) Pub. Date: May 1, 2025

(54) SYSTEM AND METHOD FOR MANAGING OPERATION OF A DEPLOYMENT BASED ON COMPATABILITY MAPPING

(71) Applicant: Dell Products L.P., Round Rock, TX (US)

(72) Inventors: CHRISTOPHER BAUER ATKINSON, Woodstock, GA (US); VINAY SAWAL, Fremont, CA (US); SUDHIR VITTAL SHETTY, Cedar Park, TX (US)

(21) Appl. No.: 18/497,469

(22) Filed: Oct. 30, 2023

(51) Int. Cl. G06F 11/34

(52) U.S. Cl. CPC G06F 11/3442; G06F 11/3433

(57) ABSTRACT

Methods and systems for managing operation of a deployment are disclosed. To manage operation of the deployment, the system may identify if a requested solution is incompatible with the deployment. If the solution is determined to be incompatible with the deployment, alternative solutions may be identified. To identify alternative solutions, the system may identify requirements of the requested solution and/or the available components of the deployment. The identified alternative solutions may be provided to a user to select at least one of the alternative solutions and/or to add additional computing components to make the deployment compatible with the solution. By doing so, the alternative solution agreed to by the user may be used to manage operation of the deployment.

### FIELD

Embodiments disclosed herein relate generally to operation management. More particularly, embodiments disclosed herein relate to systems and methods for managing operation of a deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows an interaction diagram illustrating a data flow in accordance with an embodiment.

FIGS. 2B-2D show data flow diagrams in accordance with an embodiment.

FIG. 3 shows a flow diagram illustrating a method of managing a deployment in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing deployments. A deployment may include one or more devices. The devices may include hardware and/or software components. The operation of the deployment may depend on which configuration of the deployment is requested by a user. For example, some configurations may require specific data hardware or software components not included in the deployment. As such, performing configurations using deployments with incompatible computing components (e.g., as required by the configuration) may result in failed configuration performance. To manage the operation of the deployment, the system may include an infrastructure management system (e.g., 100), The infrastructure management system may identify the requested configuration (e.g., solution) is incompatible with the deployment.

The infrastructure management system may identify alternative solutions based on requirements of the requested solution and/or the available components of the deployment. For example, the computing components (e.g., hardware and/or software components) and characteristics of the computing components (e.g., storage space, processor speed, etc.) that are required in order to provide solution may be compared to the available computing components (and/or the characteristics of the computing components) of the deployment to identify alternative solutions that may be similar to the requested solution. Based on the comparison, the infrastructure management system may provide alternative solutions to a user when the requested solution is incompatible with the deployment.

To identify alternative solutions, infrastructure management system may obtain a graph for the solution and graphs for alternative solutions reflecting the corresponding data processing systems, characteristics of the corresponding data processing systems, and/or interactions between the corresponding data processing systems for each solution. The graphs (e.g., graph for the solution and graphs for the alternative solutions) may be used to perform isometric subgraph analysis to obtain a quantification of similarity between the solution and each of the alternative solutions. Based on the quantification of similarity, the infrastructure management system may rank order the alternative solutions to provide a user with a selection of alternative solutions with a quantifiable score of similarity between the requested solution and each of the alternative solutions.

Providing the user with additional alternative solutions when the requested solution is incompatible with the deployment may enable the user (i) to select one of the additional alternative solutions to be performed by the deployment, and/or (ii) to add additional computing components (e.g., hardware components, software components, etc.) to the deployment to make the deployment compatible with the requested solution. By doing so, a system in accordance with embodiments disclosed herein may provide a deployment management framework that identifies alternative solutions when the requested solution is not compatible with the deployment based on isometric subgraph analysis, and that manages operation of the deployment based on at least one of the alternative solutions agreed to by a user of the deployment.

By doing so, a system in accordance with embodiments disclosed herein may provide a deployment management framework that identifies alternative solutions when a requested solution is incompatible with a deployment (e.g., computing components of the deployment).

In an embodiment, a method for managing operation of a deployment is provided. The method may include identifying a solution that is requested to be provided using the deployment of data processing systems; making a determination that the solution is incompatible with the deployment; based on the determination: identifying at least one alternative solution for the solution based on an isometric subgraph analysis of the solution with respect to a plurality of alternative solutions; obtaining user input indicating agreement or disagreement with use of the at least one alternative solution; in a first instance of the obtaining where the user input indicates agreement: updating operation of the deployment based on the at least one alternative solution to obtain an updated deployment; and providing computer-implemented services using the updated deployment.

Identifying the solution may include obtaining a request for the solution from a user device operated by a user.

Making the determination may include obtaining, based on the request, requirements for the solution, the requirements specifying capabilities of the deployment for the solution to be compatible with the deployment; identifying available computing components of the deployment, the available computing components being available hardware or software components of the deployment capable of performing actions to facilitate the request; and making a comparison between the requirements for the solution and the available computing components of the deployment to identify whether the solution is compatible with the deployment.

Making the comparison may include: identifying, based on the requirements for the solution, a minimum amount of computing components necessary to perform the solution; and identifying whether the available computing components meets or exceeds the minimum amount of computing components: in a first instance of the identifying where the available computing components does not meet or exceed the minimum amount of computing components: determining the solution is incompatible with the deployment.

Identifying the at least one alternative solution may include: building a first graph of the solution; obtaining a second graph of the at least one alternative solution of the plurality of the alternative solutions; performing the isometric subgraph analysis, using the first graph and the second graph, to obtain at least one quantification of at least one similarity between the solution and the at least one alternative solution; obtaining a rank order for the at least alternative solution based on the at least one quantification of the at least one similarity; selecting an alternative solution of the at least one alternative solution based at least in part on the rank ordering; and providing the selected alternative solution to the user.

The first graph may include: a plurality of nodes interconnected by edges, each node of the plurality of nodes being associated with a corresponding data processing system of the solution, each node comprising characteristics of the corresponding data processing system required by the solution, and the edges relating to required interactions between different data processing systems.

The second graph may include: a plurality of nodes interconnected by edges, each node of the plurality of nodes being associated with a corresponding data processing system of the at least one alternative solution, each node comprising characteristics of the corresponding data processing system required by the at least one alternative solution, and the edges relating to required interactions between different data processing systems.

Performing the isometric subgraph analysis may include: computing a similarity score for the second graph with respect to the first graph using an isometric subgraph analysis algorithm, the similarity score quantifying similarity between a structure of the second graph and a structure of the first graph; and obtaining, using the similarity score for each node, the at least one quantification of the at least one similarity between the solution and the at least one alternative solution.

Obtaining the user input may include: providing a notification of the at least one alternative solution to the user device; and obtaining a response from the user device, the response indicating whether the user agrees with the least one alternative solution to be performed by the deployment.

The method may further include: in a second instance of the obtaining where the user input indicates disagreement: providing additional alternative solutions to the user to select at least one of the additional alternative solutions; or providing an option to add additional hardware components to the deployment to make the deployment compatible with the solution or another solution not presented to the user previously.

Providing the additional alternative solutions to the user may include: rank ordering the additional alternative solutions based on the at least one quantification of the at least one similarity to obtain rank ordered additional alternative solutions; and providing the rank ordered additional alternative solutions to the user for selection of at least one of the additional alternative solutions.

The method may further include: in an instance of the providing where the option to add the additional hardware components is agreed to by the user: obtaining user input indicating agreement with temporary use of the at least one of the additional alternative solutions pending integration of the additional hardware components into the deployment; updating operation of the deployment based on the at least one of the additional alternative solutions to obtain a temporary updated deployment; and providing computer-implemented services using the temporary updated deployment until the additional hardware components are integrated into the deployment.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

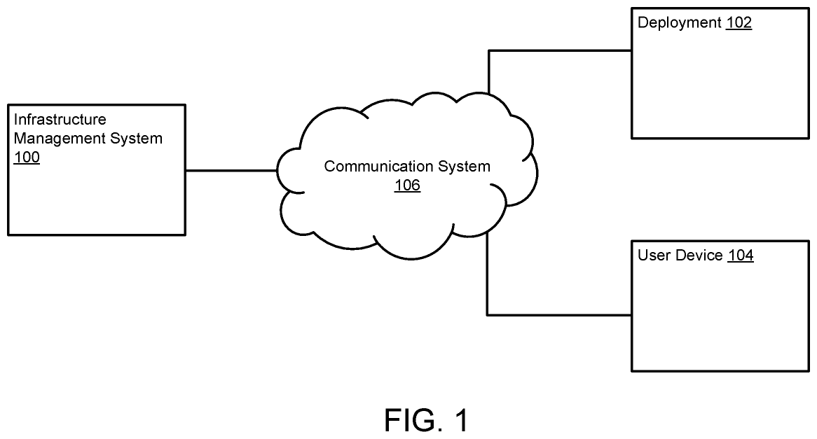

Turning to FIG. 1, a block diagram illustrating a system in accordance with an embodiment is shown. The system shown in FIG. 1 may provide computer-implemented services including databased services, instant messaging services, and/or other types of computer-implemented services.

To provide the computer implemented services, the system may include, for example, deployment 102. Deployment 102 may include any number of computing devices that provide the computer-implemented services. For example, deployment 102 may include one or more computing devices (e.g., processors, memory modules, storage devices, etc.) that may independently and/or cooperatively provide the computer-implemented services. For example, all or a portion of, deployment 102 may provide computer-implemented services to users and/or other computing devices operably connected to deployment 102. The computer implemented services may include any type and quantity of services including, for example, database services, instant messaging services, video conferencing services, etc. Different system may provide similar and/or different computer implemented services.

In order to manage operation of the computer-implement services provided by deployment 102, the system may include infrastructure management system 100. Infrastructure management system 100 may include any number of data processing systems to perform the computer-implemented services. To identify the type of computer-implemented services to perform, infrastructure management system may receive a request for a solution (e.g., configuration for operations of the deployment) from a user device (e.g., user device 104). Performance of the solution by the deployment may require specific capabilities (e.g., hardware and/or software components) of the deployment in order to facilitate integration of the solution. However, deployment 102 may lack these specific capabilities.

For example, consider a scenario where a deployment lacks the computing components such as hardware components and a solution requested by a user requires additional hardware components in order for it to be provided by the deployment. In this scenario, the infrastructure management system may notify the user of the failed implementation of the requested solution. The user may be unable to determine the issue causing the failed implementation of the requested solution and/or alternative solutions that may be provided using the deployment (e.g., available computing resources of the deployment). As a result, the failed implementation and/or lack of solution options may lead to inoperable deployment of data processing systems. Consequently, the intended use of the deployment (e.g., the computer-implemented services provided by use of the deployment) by a user may be unobtainable, thereby leading to an undesirable user experience.

Further, even if the user is able to determine the issue causing the failed implementation of the requested solution, the user may insufficient information in order to identify alternative solutions that can be provided by the available computing resources of the deployment (e.g., hardware components such as servers, processors, storage devices, etc.).

Thus, even when notified of the failed implementation of a requested solution, users may be unable to identify alternative solutions for the deployment to provide similar computer-implemented services temporarily until additional hardware components are integrated into the deployment.

In general, embodiments disclosed herein may provide methods, systems, and/or devices for managing operation of deployments. To manage operation of a deployment, a request for a solution to be provided using the deployment (e.g., computing resources of the deployment) may be identified. Based on the identified solution (e.g., solution requirements), a determination may be made regarding whether the deployment is capable of providing the identified solution. If the requested solution is incompatible with the deployment (e.g., insufficient computing components), infrastructure management system 100 may use the identified information (e.g., solution requirements, deployment resources, etc.) to identify compatible solutions and/or similar solutions (e.g., comparative to the requested solution) that may be provided using the deployment (e.g., available computing resources) to attempt to effectuate a similar goal presented by the request. By doing so, alternative solutions may be presented to the user (e.g., of the deployment) to select an acceptable alternative solution and/or confirm how to proceed in view of the requested solution being unavailable. The accepted alternative solution (e.g., if so indicated by the user) may be used to manage the operation of the deployment in order to provide the computer-implemented services.

To provide the above noted functionality, the system may include infrastructure management system 100, deployment 102, user device 104, and communication system 106. Each of these components is discussed below.

Infrastructure management system 100 may manage deployment 102 to provide desired computer implemented services. To manage deployment 102, infrastructure management system 100 may participate in deployment management services provided in cooperation with deployment 102. To participate in the deployment management services, infrastructure management system 100 may (i) obtain a request for a solution to be provided using the deployment of data processing systems, (ii) determine whether the solution is compatible with the deployment (e.g., deployment computing resources), (iii) based on the determination indicating incompatibility (e.g., between the solution and the deployment), identify alternative solutions for the solution based on an isometric subgraph analysis of the solution, (iv) obtain user input indicating agreement or disagreement with use of at least one of the alternative solutions, (v) manage operation of the deployment based on the at least one of the alternative solutions, and/or (vi) perform other processes to facilitate management of deployment 102.

User device 104 may also participate in the deployment management services. When participating in the deployment management services, user device 104 may (i) provide requests for solutions (e.g., indicated via user input) to infrastructure management system 100, (ii) receive information regarding alternative solutions, (iii) obtain user input regarding agreement or disagreement with use of alternative solutions, and/or (iv) obtain user input regarding an option to add additional computing resources to make the deployment compatible with the solution.

Deployment 102 may contribute to performance of the deployment management services. When contributing to performance of the deployment management services, deployment 102 may (i) provide information regarding the deployments computing resources to infrastructure management system 100, (ii) obtain information regarding solutions be provided to update the operation of the deployment (e.g., an automation framework hosted by data processing systems of deployment 102 may update the operation of the data processing systems based on the information), and/or (iii) provide the computer-implemented services to users (e.g., users of deployment 102).

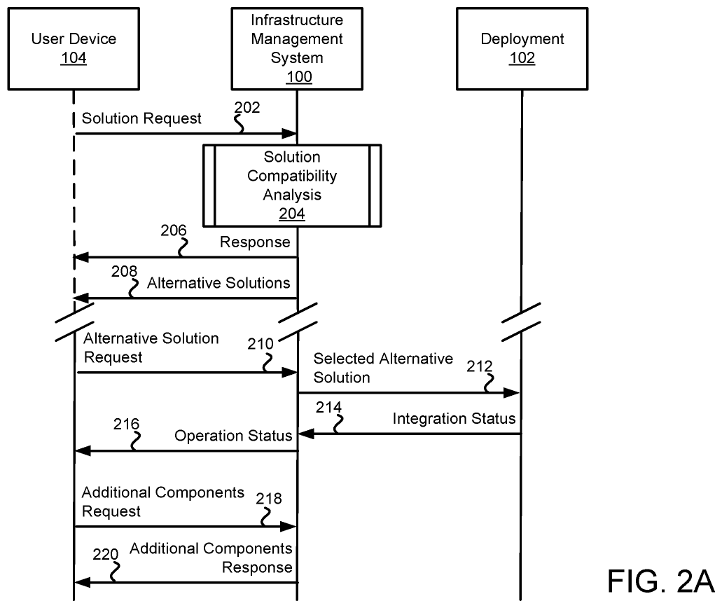

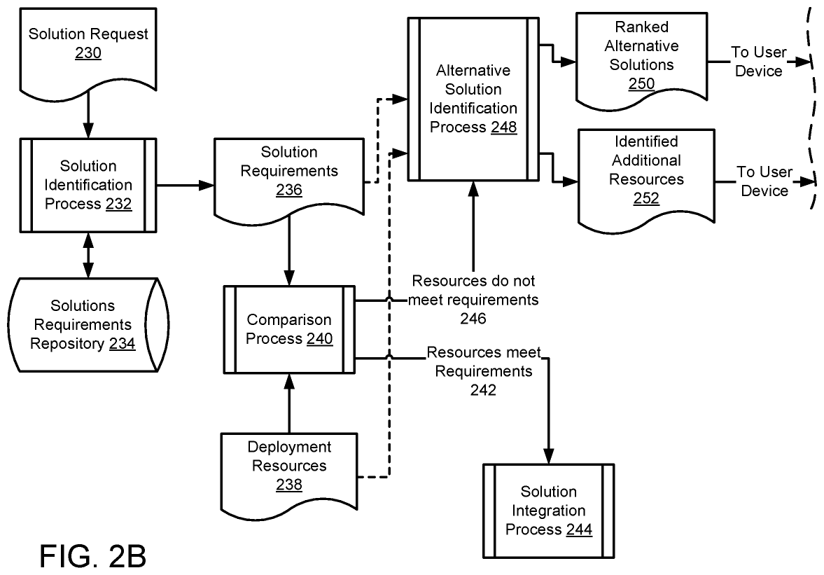

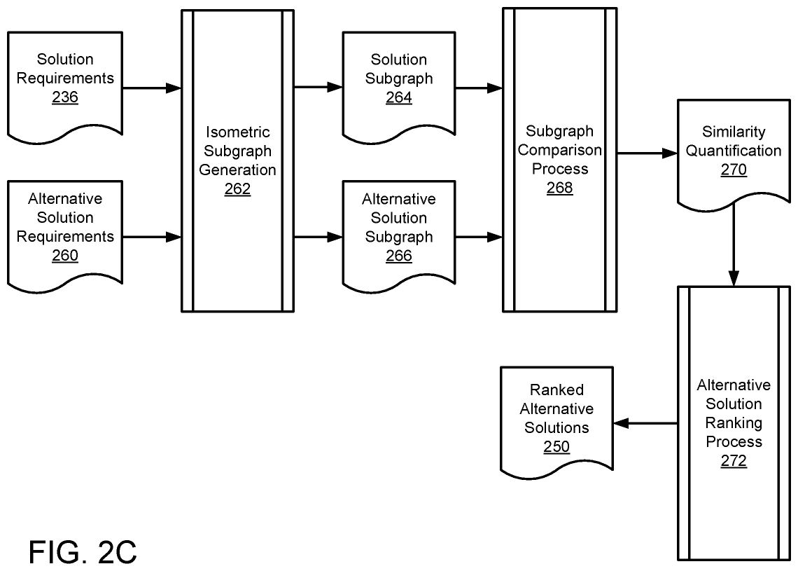

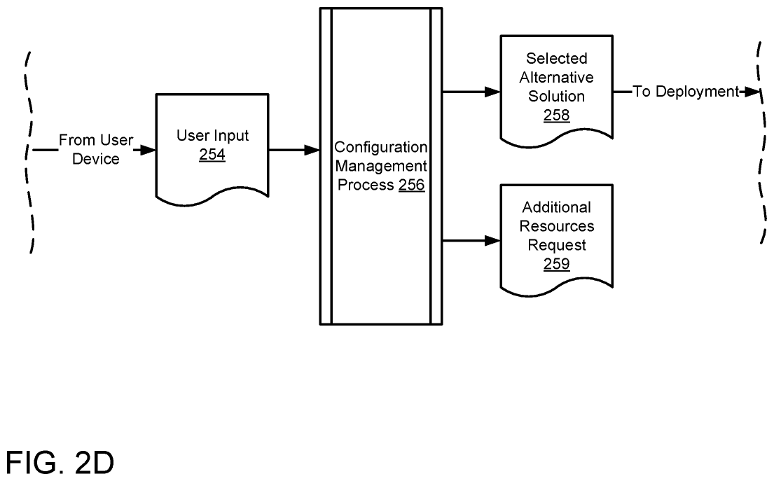

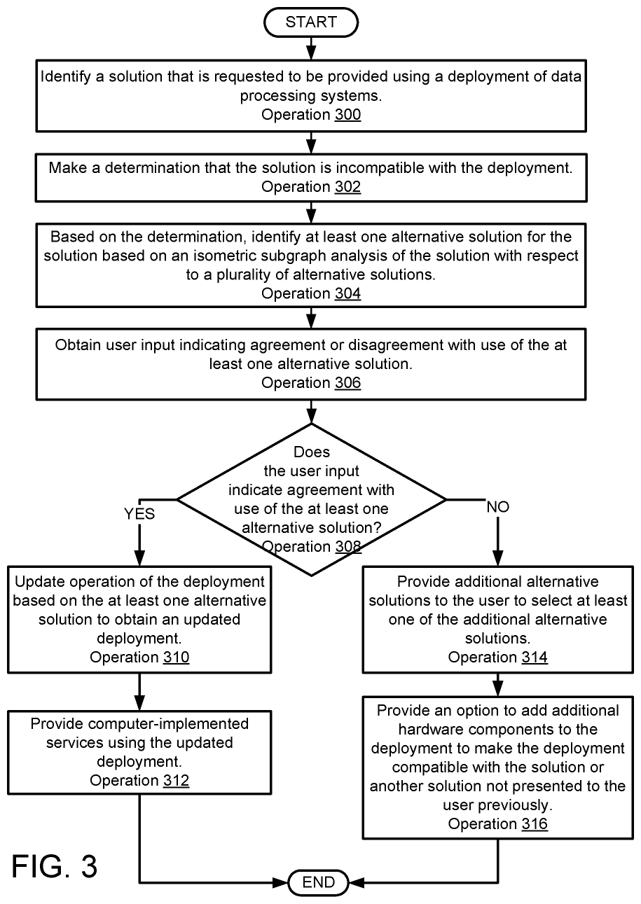

When providing their functionalities, infrastructure management system 100, deployment 102 (and/or components thereof), and/or user device 104 may perform all, or a portion, of the methods and/or actions shown in FIGS. 2A-3.

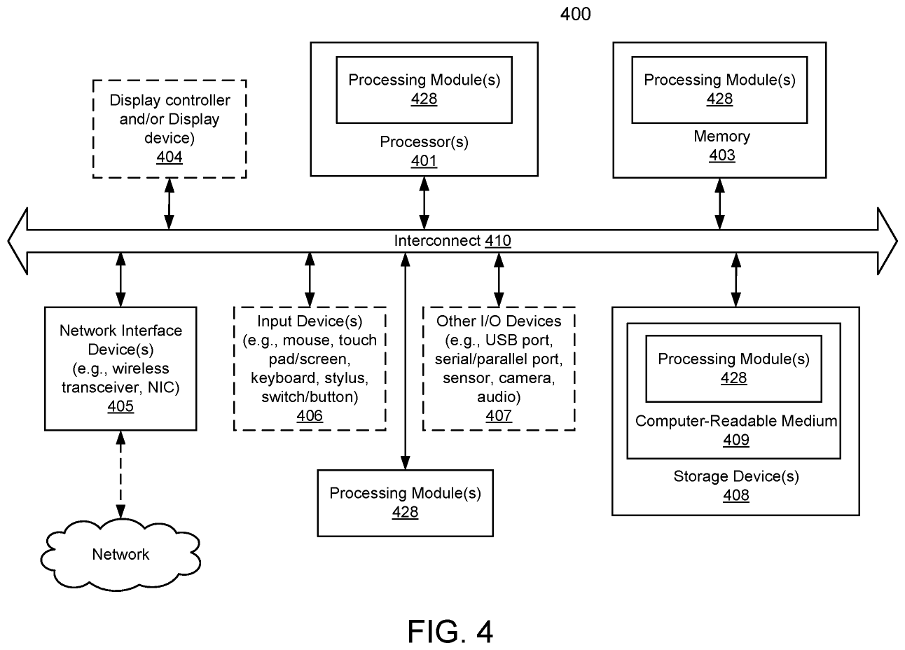

Infrastructure management system 100, deployment 102 (and/or components thereof), and/or user device 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. In an embodiment, communication system 104 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, an interaction diagrams in accordance with an embodiment is shown in FIG. 2A. The interactions diagram may illustrate how data may be obtained and used within the system of FIG. 1.

In the interaction diagram, processes performed by and interactions between components of a system in accordance with an embodiment are shown. In the diagram, components of the system are illustrated using a first set of shapes (e.g., 104, 100, etc.), located towards the top of each figure. Lines descend from these shapes. Processes performed by the components of the system are illustrated using a second set of shapes (e.g., 204, etc.) superimposed over these lines. Interactions (e.g., communication, data transmissions, etc.) between the components of the system are illustrated using a third set of shapes (e.g., 202, 206, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 206. However, it will be appreciated that the processes and interactions may be performed in different orders, any may be omitted, and other processes or interactions may be performed without departing from embodiments disclosed herein.

The lines descending from some of the first set of shapes (e.g., 100, 104, etc.) is drawn in dashing to indicate, for example, that the corresponding components may not be (i) operable, (ii) powered on, (iii) present in the system, and/or (iv) not participating in operation of the system for other reasons.

Turning to FIG. 2A, an interaction diagram in accordance with an embodiment is shown. The interaction diagram may illustrate processes and interactions that may occur during managing operation of a deployment.

Now, consider an example scenario where user device 104 (e.g., used by an operator of deployment 102) wishes to implement a solution using deployment 102 (e.g., computing resources of deployment 102). To do so, the user (e.g., via user device 104) may initiate contact with infrastructure management system 100.

At interaction 202, the solution request may be provided to infrastructure management system 100 by user device 104. For example, the solution request may be generated and provided to infrastructure management system 100 via (i) transmission via a message, (ii) storing in a storage with subsequent retrieval by infrastructure management system 100, (iii) via a publish-subscribe system where infrastructure management system 100 subscribes to updates from user device 104 thereby causing a copy of the solution request to be propagated to infrastructure management system 100, and/or via other processes. By providing the solution request to infrastructure management system 100, infrastructure management system 100 may provide deployment management services by identifying compatibility of a solution with the deployment based on the requested solution of the user (e.g., user device 104). For example, a type of solution that is requested may be ascertained based on the solution request.

To manage deployment operations, solution compatibility analysis process 204 may be performed. During solution compatibility analysis process 204, the solution request may be ingested and analyzed with respect to deployment 102 for compatibility. The analysis of the solution request may be performed to obtain (i) an identity of the solution requested, (ii) requirements for the requested solution (e.g., computing resources necessary to provide the requested solution), (iii) information regarding the deployment resources that are available for implementing the requested solution, and/or (iv) any other information necessary to perform solution compatibility analysis process 204.

Based on the analysis of the request for a solution, requirements corresponding to the solution may be identified. To identify the requirements, the requested solution may be pre-associated with one or more requirements (e.g., solution requirements 236 shown in FIG. 2B) relevant to a solution. For example, infrastructure management system 100 may use the requested solution as a key to perform a look up for requirements associated with the requested solution (e.g., necessary computing resources, solution implementation procedures, etc.) stored in, for example, a solution requirements repository (e.g., solution requirements repository 234 shown in FIG. 2B) within infrastructure management system 100.

In addition, based on the analysis of the solution request, solution compatibility analysis process 204 may identify computing resources corresponding to the deployment (e.g., deployment 102) which is to be used in providing the requested solution. In some instances, the identity of the user device (e.g., user device 104) may be associated with a deployment (e.g., 102). For example, infrastructure management system 100 may use an identity of a user such as account number, full name, and/or any other information associated with the user (e.g., user device 104) as a key to perform a look up for the associated deployment (e.g., computing resources) stored in, for example, a data repository (not shown) within infrastructure management system 100.

Once obtained, the identified solution requirements and deployment resources may be used, at least in part, during solution compatibility analysis process 204 to determine whether the solution (e.g., solution request) is compatible with the deployment (e.g., computing resources of the deployment). In some instances, the solution may be incompatible with the deployment if the deployment resources do not meet the solution requirements (e.g., computing resources necessary to perform the solution). For example, infrastructure management system 100 may use the identified solution requirements to determine if the available deployment resources (e.g., hardware and/or software components) are capable of performing the requested solution.

In some instances, when the requested solution is determined to be incompatible with the deployment, the identified solution requirements and deployment resources may be used, at least in part, during solution compatibility analysis process 204 to identify alternative solutions compatible with the deployment (e.g., computing resources of the deployment). The alternative solutions that are compatible the deployment may be based, at least in part, on the capabilities of the deployment resources (e.g., memory, processing power, etc.). For example, the deployment resources may include hardware components such as servers, computers, etc. that affect the capability of the deployment to perform certain solutions.

At interaction 206, the response may be provided to user device 104 by infrastructure management system 100. For example, the response may be generated and provided to user device 104 via (i) transmission via a message, (ii) storing in a storage with subsequent retrieval by user device 104, (iii) via a publish-subscribe system where user device 104 subscribes to updates from infrastructure management system 100, and/or via other processes.

At interaction 208, the alternative solutions obtained through solution compatibility analysis process 204 may be provided to user device 104 by infrastructure management system 100. For example, the alternative solutions may include a notification of alternative solutions (e.g., associated with the requested solution) generated and provided to user device 104 via (i) transmission via a message, (ii) storing in a storage with subsequent retrieval by user device 104, (iii) via a publish-subscribe system where user device 104 subscribes to updates from infrastructure management system 100 thereby causing a copy of the alternative solutions to be propagated to user device 104, and/or via other processes. By providing the alternative solutions to user device 104, user device 104 may provide an alternative solution request specifying at least one alternative solution from the alternative solutions in which is to be performed by the deployment.

At interaction 210, based on the alternative solutions previously obtained, an alternative solution request may be provided to infrastructure management system 100. The alternative solution request may be a request from user device 104 and may include information indicating how to proceed with respect to the requested solution. The alternative solution request may include information indicating agreement with one of the alternative solutions obtained at interaction 208, that additional resources for the deployment should be added to place deployment 102 into compatibility with the originally requested solution, etc.

The alternative solution request may be generated and provided to infrastructure management system 100 via (i) transmission via a message, (ii) storing in a storage with subsequent retrieval by infrastructure management system 100, (iii) via a publish-subscribe system where infrastructure management system 100 subscribes to updates from user device 104 thereby causing a copy of the alternative solution request to be propagated to infrastructure management system 100, and/or via other processes. By providing the alternative solution request to infrastructure management system 100, infrastructure management system 100 may provide a selected alternative solution to deployment 102, which may initiate implementation of the alternative solution.

At interaction 212, the selected alternative solution may be provided to deployment 102 by infrastructure management system 100. The selected alternative solution my include instructions based on the alternative solution request to implement the path for proceeding indicated by alternative solution request. For example, the selected alternative solution may be provided to deployment 102 via (i) transmission via a message, (ii) storing in a storage with subsequent retrieval by deployment 102, (iii) via a publish-subscribe system where deployment 102 subscribes to updates from infrastructure management system 100 thereby causing a copy of the alternative solution request to be propagated to deployment 102, and/or via other processes. By providing the selected alternative solution to deployment 102, deployment 102 may provide services relevant to the selected alternative solution.

At interaction 214, an integration status may be provided to infrastructure management system 100 by deployment 102. The integration status may indicate that deployment 102 has updated its operation to comply with the selected alternative solution. For example, the integration status may be generated and provided to infrastructure management system via (i) transmission via a message, (ii) storing in a storage with subsequent retrieval by infrastructure management system 100, (iii) via a publish-subscribe system where infrastructure management system 100 subscribes to updates from deployment 102 thereby causing a copy of the integration status to be propagated to infrastructure management system 100, and/or via other processes. By providing the integration status to infrastructure management system 100, infrastructure management system 100 may provide a status of integration of the selected alternative solution.

At interaction 216, an operation status may be provided to user device 104 by infrastructure management system 100. The operation status may indicate that deployment 102 is operating in accordance with the requested alternative solution. For example, the operation status (e.g., of the selected alternative solution being provided by deployment 102) may be provided to user device 104 via (i) transmission via a message, (ii) storing in a storage with subsequent retrieval by user device 104, (iii) via a publish-subscribe system where user device 104 subscribes to updates from infrastructure management system 100 thereby causing a copy of the operation status to be propagated to user device 104, and/or via other processes. By providing the operation status to user device 104, user device 104 may provide a status of operations of the selected alternative solution being performed by deployment 102, which may indicate successful integration or failed integration of the selected alternative solution by deployment 102.

As discussed above, a user may, at interaction 210, elect to, rather than accept an alternative solution, request and wait for delivery of hardware/software to place deployment 102 into compatibility with the originally-requested solution.

At interaction 218, additional components request may be provided to infrastructure management system 100 by user device 104. For example, the additional components request may include information relating to computing components selected by a user (e.g., additional hardware and/or software components) generated and provided to infrastructure management system 100 via (i) transmission via a message, (ii) storing in a storage with subsequent retrieval by infrastructure management system 100, (iii) via a publish-subscribe system where infrastructure management system 100 subscribes to updates from user device 104 thereby causing a copy of the additional components request to be propagated to infrastructure management system 100, and/or via other processes. By providing the additional components request to infrastructure management system 100, infrastructure management system 100 may identify the requested additional components and provide a response to the additional components request in which the additional components responsive to the additional components request is provided or withheld from user device 104. The additional components may be ordered and placed in transit to deployment 102 for eventually updating of deployment 102 to place it into compatibility with the originally requested solution.

At interaction 220, additional components response may be provided to user device 104 by infrastructure management system 100. The additional components response may confirm that the additional components will eventually be used to update deployment 102 to place it into compatibility with the originally requested solution (e.g., at interaction 202). For example, the additional components response may be generated and provided to user device 104 via (i) transmission via a message, (ii) storing in a storage with subsequent retrieval by user device 104, (iii) via a publish-subscribe system where user device 104 subscribes to updates from infrastructure management system 100 thereby causing a copy of the additional components response to be propagated to user device 104, and/or via other processes. By providing the additional components response to user device 104, user device 104 may provide services relating to the additional components response.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows and processes shown in FIG. 2A, deployment operation may be automatically managed via identification of alternative solutions based on a requested solution.

To further clarify embodiments disclosed herein, data flow diagrams in accordance with an embodiment are shown in FIGS. 2B-2D. The data flow diagrams may illustrate how data is obtained and used within the system of FIGS. 1-2A. In these diagrams, flows of data and processing of data are illustrated using different sets of shapes. A first set of shapes (e.g., 230, 236, etc.) is used to represent data structures, a second set of shapes (e.g., 232, 240, etc.) is used to represent processes performed using and/or that generate data, and a third set of shapes (e.g., 234, etc.) is used to represent large scale data structures such as databases.

Turning to FIG. 2B, a first data flow diagram illustrating data flows, data processing, and/or other operations that may be performed by the system of FIG. 1 in accordance with an embodiment is shown. The data flows, data processing, and/or other operations may be performed in determining whether a requested solution is compatible with a deployment (e.g., deployment computing resources) in order to manage operation of the deployment.

In order to manage operation of the deployment (e.g., 102 shown in FIG. 1), infrastructure management system 100 (shown in FIG. 1) may obtain solution requirements 236 for the requested solution (e.g., 230), and initiate determining of whether the requested solution is compatible with the deployment (e.g., computing resources of the deployment). For example, the determination may include comparing the solution requirements (e.g., necessary capabilities to perform the requested solution) and the computing resources of the deployment (e.g., deployment resources 328) to identify whether the requested solution may be performed by the deployment. Based on the determination indicating incompatibility, the infrastructure management system 100 (shown in FIG. 1) may initiate identifying alternative solutions which may be provided to a user device (e.g., 104 shown in FIG. 1) for selection of at least one of the alternative solutions to be provided using the deployment. By doing so, the selected alternative solution may be used to manage operation of the deployment.

In order to obtain solution requirements (e.g., 236), solution identification process 232 may be performed. During solution identification process 232, solution request 230 may be obtained, for example, from a user device (e.g., 104; FIG. 1), to initiate identification of requirements for the solution. For example, during solution identification process 232, the solution may be identified (e.g., via solution request 230) and used as a key to perform a look up to identify the requirements associated with the solution (e.g., solution requirements 236).

Solution requirements 236 may include any type of information specifying the capabilities of the deployment for the solution in order to be compatible with the deployment. For example, solution requirements 236 may provide information indicating the necessary computing resources (e.g., application server, processor, etc.) in order to perform the respective solution. To differentiate information regarding different types of computing resources, solution requirements 236 may be organized as, for example, a table including rows corresponding to each of the computing resources for the respective solution. Each row may include information regarding a corresponding computing resource (e.g., hardware component) necessary to perform the solution. Further, the rows may be keyed to facilitate efficient searches based on, for example, type of computing resource, characteristics of the computing resource, and/or any other information to identify computing resources.

Similarly, deployment resources 238 of the deployment in which is to provide the solution requested may also be obtained. Deployment resources 238 may indicate the available computing components of the deployment to perform actions to facilitate the requested solution. For example, deployment resources 238 may include any information identifying the available hardware or software components of the deployment and/or characteristics of the computing components of the deployment. In some instances, deployment resources 238 (e.g., hardware or software components) may be registered to an associated user and/or user device (e.g., 104 shown in FIG. 1) and identifiable based, at least in part, on the requested solution (e.g., solution request 230). For example, infrastructure management system 100 (e.g., shown in FIG. 1) may perform a look up process using the identity of the user device (e.g., specified by solution request 230) as a key to identify the associated deployment resources (e.g., which may be stored in searchable format within a deployment database or repository; not shown).

To make a determination regarding whether the solution is compatible with the deployment (e.g., 102 shown in FIG. 1), solution requirements 236 and deployment resources 238 may be used. Solution requirements 236 and deployment resources 238 may be used as part of comparison process 240 to make the determination. Comparison process 240 may identify, for example, whether the available computing resources of the deployment (e.g., deployment resources 238) are sufficient to perform the solution.

For example, comparison process 240 may be performed by comparing the available computing components of the deployment (e.g., deployment resources 238) to the requirements for the solution (e.g., solution requirements 236). If the comparison indicates the available computing components does meet or exceed the minimum amount of computing components necessary to perform the solution (e.g., resources meet requirements 242), then the data flow may proceed to perform solution integration process 244. Solution integration process 244 may include providing the deployment with any information necessary to perform the solution. For example, solution integration process 244 may include communications from infrastructure management system 100 to deployment 102 regarding instructions or workflow sequences to be performed by computing resources of the deployment (e.g., executable instructions that define an order of computing resources performing tasks to implement the solution).

In contrast, if the comparison indicates the available computing components does not meet or exceed the minimum amount of computing components necessary to perform the solution (e.g., resources do not meet requirements 246), then the data flow may proceed to perform alternative solution identification process 248. During alternative solution identification process 248, alternative solutions to the solution and/or the additional computing resources needed to perform the requested solution may be identified.

Alternative solution identification process 248 may include performing isometric subgraph analysis based, at least in part, on solution requirements 236 and deployment resources 238 to obtain ranked alternative solutions 250. Ranked alternative solutions 250 may include ranked ordered alternative solutions based on similarity of each alternative solution to the solution. Refer to FIG. 2C for additional details regarding obtaining ranked alternative solutions 250.

Alternative solution identification process 248 may further include identifying additional computing resources to add to the deployment in order to make the deployment compatible with the solution and/or another solution not presented to the user previously (e.g., via ranked alternative solutions 250). For example, during alternative solution identification process 248, deployment resources 238 and solution requirements 2236 may be analyzed by infrastructure management system 100 (e.g., shown in FIG. 1) to identify the computing resources necessary to perform the solution requested (e.g., identified additional resources 252).

Identified additional resources 252 may include information identifying any number of computing resources (e.g., hardware components) that are needed in order for a deployment to perform a solution (and/or another solution not requested by a user via user device). Identified additional resources 252 may be provided, for example, to a user device (e.g., user device 104 shown in FIG. 1) by infrastructure management system 100 to provide a user with the option to add additional hardware components to deployment resources 238.

Thus, using the data flows and processes shown in FIG. 2B, operation of a deployment may be automatically managed by determining whether a solution is compatible with the deployment and/or identifying alternative solutions to provide to a user device in instances when the solution is determined to be incompatible with the deployment.

Turning to FIG. 2C, a second data flow diagram illustrating data flows, data processing, and/or other operations that may be performed by the system of FIG. 1 in accordance with an embodiment is shown. The data flows, data processing, and/or other operations may be performed in obtaining alternative solutions when a requested solution is determined to be incompatible with the deployment (e.g., deployment computing resources).

As discussed above, managing operation of a deployment (e.g., 102 shown in FIG. 1) may include identifying a solution that is requested to be provided using the deployment of data processing systems and determining whether the solution is compatible with the deployment. In some instances, the solution may be determined to be incompatible with the deployment, for example, if the necessary computing resources to perform the solution is not available or a part of the deployment resources. In those instances where the solution is incompatible with the deployment, alternative solutions (e.g., comparative to the requested solution) may be identified and provided to a user device (e.g., 104; FIG. 1) for selection of at least one of the alternative solutions.

In order to identify alternative solutions that are similar to the solution (e.g., requested solution), isometric subgraph generation process 262 may be performed. During isometric subgraph generation process 262, graphs for the solution and other solutions may be generated. The respective graphs for the solution and other alternative solutions may be generated based on the requirements necessary to perform the respective solution (e.g., data processing systems, characteristics of the data processing systems, etc.). For example, a first graph for the solution (e.g., solution subgraph 264) may include a plurality of nodes interconnected by edges with each node being associated with a data processing system (and/or a characteristic of the data processing system) of the respective solution, and the edges relating to required interactions between the different data processing systems of the respective solution.

During isometric subgraph generation 262, a graph for each of the alternative solutions (e.g., other solutions identified via storage in a data repository (not shown)) may be generated in a manner similar to the requested solution. The graph for each of the alternative solutions may be generated based on the respective requirements for each alternative solution. Continuing the above example, a second graph for at least one alternative solution (e.g., alternative solution subgraph 266) may include a plurality of nodes interconnected by edges with each node being associated with a data processing system (and/or characteristic of the data processing system) of one of the alternative solutions, and the edges relating to required interactions between the different data processing systems of the respective alternative solution.

Prior to generating a graph for each alternative solution during isometric subgraph generation process 262, alterative solution requirements 260 may be obtained. Alternative solution requirements 260 may be obtained, for example, from a solutions repository (e.g., repository containing solution requirements for various solutions; not shown) by infrastructure management system 100 (e.g., shown in FIG. 1). Alternative solution requirements 260 may identify the requirements for each alternative solution such as the computing resources (e.g., data processing systems) necessary to perform the respective alternative solution and a workflow of the computing resources (e.g., interaction procedures between the computing resources).

Once obtained, the graph for the solution and the graph for each alternative solution may be ingested and used in a comparison process (e.g., subgraph comparison process 268) in order to identify similarities between the solution and each respective alternative solution. For example, the graph or subgraph (e.g., portion of the graph) of the solution (e.g., solution subgraph 264) and the graph or subgraph of the alternative solution (e.g., alternative solution subgraph 266) may be ingested during subgraph comparison process 268 to obtain at least one quantification of similarity between the solution and the alternative solution (e.g., similarity quantification 270).

Subgraph comparison process 268 may be performed by computing a similarity score for the alternative solution graph with respect to the solution graph using an isometric subgraph analysis algorithm. The similarity score may quantify similarity between a structure of the alternative solution graph and a structure of the solution graph. For example, each node of the alternative solution graph (e.g., alternative solution subgraph 266) may be compared to each node of the solution graph (e.g., solution subgraph 264) during isometric subgraph analysis in order to obtain a similarity score for the structure of the alternative solution graph.

Once obtained, the similarity score for each node may be used during subgraph comparison process 268 to obtain the at least one quantification of similarity between the solution and the alternative solution (e.g., similarity quantification 270).

Subgraph comparison process 268 may be performed multiple times using subgraphs generated for different alternative solutions based on the respective alternative solution requirements (e.g., requirements associated with each alternative solution). By performing subgraph comparison process 268 using the subgraphs associated with various alternative solutions, a quantification of at least one similarity between the solution and the respective alternative solution may be obtained. The resulting quantification of similarity for each alterative solution may be provided to alternative solution ranking process 272 to obtain a rank order for the alternative solutions.

To obtain a rank order for the alternative solutions, alternative solution ranking process 272 may be performed. During alternative solution ranking process 272, the quantification of similarity for each alternative solution (e.g., similarity quantification 270) may be analyzed and used to obtain a ranking order of the alternative solutions based on each of the alternative solutions similarity to the solution. The ranking order of the alternative solutions may provide a hierarchy ranking of the alternative solutions with the highest ranked ordered alternative solution being the most similar alternative solution (e.g., highest similarity quantification) and the lowest ranked ordered alternative solution being the least similar alternative solution (e.g., lowest similarity quantification).

Ranked alternative solutions 250 may include any type and quantity of information regarding any number of the rank ordered alterative solutions. For example, ranked alternative solutions 250 may include a list identifying the rank ordered alternative solutions and/or each alternative solutions respective similarity quantifications (e.g., similarity quantification 270).

Ranked alternative solutions 250 may be provided to a user device (e.g., user device 104; FIG. 1) to allow a user to select at least one of the alternative solutions to be provided by the deployment (e.g., 102 shown in FIG. 1). Refer to FIG. 2B for additional details regarding ranked alternative solutions.

Turning to FIG. 2D, a third data flow diagram illustrating data flows, data processing, and/or other operations that may be performed by the system of FIG. 1 in accordance with an embodiment is shown. The data flows, data processing, and/or other operations may be performed in obtaining an updated deployment based on a selected resolution indicated by user input.

As described above, in some instances, the requested solution (e.g., solution request 230 shown in FIG. 2B) may be incompatible with the deployment, for example, based on inadequate computing resources of the deployment necessary to perform the solution. As such, alternative solutions may be obtained, ranked (e.g., based on similarity to the solution), and provided to the user (e.g., via user device 104) as well as identification of the additional computing resources (e.g., 252 shown in FIG. 2B) needed in order to perform the requested solution. Based on the user's selected resolution (e.g., decision to implement one of the ranked alternative solutions and/or agreement to add additional computing components), an updated deployment may be obtained.

In order to obtain an updated deployment (e.g., 102; FIG. 1), configuration management process 256 may be performed. During configuration management process 256, user input 254 may be obtained, for example, from a user device (e.g., 104; FIG. 1), to initiate identification of a selected alternative solution and/or a request for additional computing resources to integrate with the deployment resources. User input 254 may include a response indicating whether a user agrees with at least one alternative solution to be performed by the deployment. For example, configuration management process 256 may identify the selected alternative solution (e.g., 258) agreed to by the user (e.g., via user input 254) and provide selected alternative solution 258 (e.g., including any information necessary to perform the selected alternative solution) to the deployment (e.g., 102 shown in FIG. 1).

In some instances, user input 254 may indicate a user's agreement to exercise the option to add the additional computing resources to the deployment (e.g., 102 shown in FIG. 1). For example, a user may submit input (e.g., via user device shown in FIG. 1) indicating a request for additional computing resources (e.g., hardware components) to add to the current computing resources of the deployment in order to perform the solution requested by the user (e.g., solution request 230 shown in FIG. 2B). During configuration management process 256, user input 254 may be obtained and analyzed, for example, by infrastructure management system 100 (e.g., shown in FIG. 1) to identify the request for the additional computing resources (e.g., additional resources request 259).

Additional resources request 259 may include a request specifying the additional hardware components to add to a deployment (e.g., 102 shown in FIG. 1) in order to make the deployment compatible with the solution or another solution not presented to the user (e.g., via user device 104) previously. Additional resources request 259 may be used to manage the addition of the computing components necessary to perform the solution (e.g., solution request 230).

In some instances, user input 254 may indicate a user's agreement with temporary use of at least one of the alternative solutions while the integration of additional hardware components into the deployment is pending. For example, during configuration management process 256, user input 256 may be analyzed by infrastructure management system (e.g., 100 shown in FIG. 1) in order to identify a user's agreement to temporary use of one of the alternative solutions (e.g., selected alternative solution 258) while the request for adding additional resources to the deployment (e.g., additional resources request 259) may be processed and resolved (e.g., until the additional hardware components are integrated into the deployment).

Continuing the above example, operation of the deployment may be temporarily updated by providing the selected alterative solution to obtain a temporary updated deployment. For example, selected alternative solution 258 may be provided to the deployment (e.g., 102 shown in FIG. 1) to use for a period of time until the additional hardware components (e.g., specified via additional resources request 259) are integrated into the deployment. As a result, the deployment may provide computer-implemented services until the additional hardware components are integrated into the deployment.

As discussed above, the components of FIG. 1 may perform various methods to manage data processing systems of deployments. FIG. 3 illustrates a method that may be performed by the components of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by a data processing system, a management system, a communication system, a management controller, hardware resources, and/or other components illustrated in FIGS. 1-2D.

At operation 300, a solution that is requested to be provided using a deployment of data processing systems may be identified. The solution may be identified by (i) reading it from storage, (ii) receiving the solution from a user device and/or another entity via communication by a data processing system, and/or (iii) any other methods. The solution may be requested by the user (e.g., via a user device) in which the deployment will provide computer-implemented services (e.g., instant messaging, consumer product selection, etc.).

At operation 302, a determination that the solution is incompatible with the deployment may be made. To make the determination, an analysis process may be performed and which may include (i) obtaining, based on the request, requirements for the solution, the requirements specifying capabilities of the deployment for the solution to be compatible with the deployment, (ii) identifying available computing components of the deployment, the available computing components being available hardware or software components of the deployment capable of performing actions to facilitate the request, and/or (iii) making a comparison between the requirements for the solution and the available computing components of the deployment to identify whether the solution is compatible with the deployment.

At operation 304, based on the determination, at least one alternative solution for the solution may be identified. The at least one alternative solution may be identified based on an isometric subgraph analysis of the solution with respect to a plurality of alternative solutions. To identify the at least one alternative solution may include (i) building a first graph of the solution, (ii) obtaining a second graph of the at least one alternative solution of the plurality of alternative solutions, (iii) performing the isometric subgraph analysis, using the first graph and the second graph, to obtain at least one quantification of at least one similarity between the solution and the least one alternative solution, (iv) obtaining a rank order for the at least alternative solution based on the at least one quantification of the at least one similarity, (v) selecting an alternative solution of the at least one alternative solution based at least in part on the rank ordering, and/or (vi) providing the selected alternative solution to the user. The first graph may include a plurality of nodes interconnected by edges with each node of the plurality of nodes being associated with a corresponding data processing system of the solution. Each node may include characteristics of the corresponding data processing system required by the solution and the edges relating to required interactions between different data processing systems.

Performing the isometric subgraph analysis may include: (i) computing a similarity score for the second graph with respect to the first graph using an isometric subgraph analysis algorithm, (ii) obtaining, using the similarity score for each node, the at least one quantification of the at least one similarity between the solution and the at least one alternative solution, and/or (iii) by any other methods. The similarity score may quantify similarity between a structure of the second graph and a structure of the first graph.

At operation 306, user input indicating agreement or disagreement with use of the at least one alternative solution may be obtained. Obtaining the user input may include (i) providing a notification of the at least one alternative solution to the user device, and/or (ii) obtaining a response from the user device. The response may indicate whether the user agrees with at least one alternative solution to be performed by the deployment.

Providing the notification of the at least one alternative solution to the user device may include (i) providing, via wireless communication, a message indicating the solution is incompatible with the deployment, (ii) providing, via wireless communication, a message indicating the at least one alternative solution, and/or (iii) any other methods to facilitate providing the notification of the at least one alternative solution to the user device.

Obtaining the response from the user device may be facilitated by (i) receiving the response via wireless communication from the user device, (ii) reading the response from storage, and/or (iii) any other methods.

At operation 308, a determination is made regarding whether the user input indicates agreement with use of the at least one alternative solution. The determination may be based on the user input obtained, for example, from a user device.

If it is determined that the user input indicates agreement with use of the at least one alternative solution (e.g., the determination is “Yes” at operation 308), then the method may proceed to operation 310.

At operation 310, operation of the deployment may be updated based on the at least one alternative solution to obtain an updated deployment. Operation of the deployment may be updated by (i) providing the at least one alternative solution to the deployment,

At operation 312, computer-implemented services may be provided using the updated deployment. The computer-implemented services may be provided using the updated deployment by (i)

The method may end following operation 312.

Returning to operation 308, if it is determined that the user input does not indicate agreement (e.g., indicates disagreement) with use of the at least one alternative solution (e.g., the determination is “No” at operation 308), then the method may proceed to operation 314.

At operation 314, additional alternative solutions are provided to the user to select at least one of the additional alternative solutions. Providing the additional alternative solutions may include (i) rank ordering the additional alternative solutions based on the at least one quantification of the at least one similarity to obtain rank ordered additional alternative solutions, and/or (ii) providing the rank ordered additional alternative solutions to the user for selection of at least one of the additional alternative solutions.

Rank ordering the additional alternative solutions may include obtaining the at least one quantification of the at least one similarity and performing a ranking process of the additional alternative solutions based on their associated at least one quantification of the at least one similarity.

The rank ordered additional alternative solutions may be provided to the user by (i) sending a notification of the rank ordered additional alternative solutions to the user via communication by a data processing system, (ii) generating and providing a selection list of the rank ordered additional solutions to the user via portal (e.g., a website, an application, etc.) in order for the user to select one of the rank ordered additional solutions, and/or (iii) any other methods.

At operation 316, an option to add additional hardware components to the deployment may be provided. Providing the option to add additional hardware components may make the deployment compatible with the solution or another solution not presented to the user previously. Providing the option to add the additional hardware components may include (i) notifying the user of the option to add the additional hardware components, and/or (ii) receiving a response from the user indicating whether the option to add the additional hardware components is agreed to by the user.

In an instance of the providing where the option to add the additional hardware components is agreed to by the user, the method may include (i) obtaining user input indicating agreement with temporary use of the at least one of the additional alternative solutions pending integration of the additional hardware components into the deployment, (ii) updating operation of the deployment based on the at least one of the additional alternative solutions to obtain a temporary updated deployment, and/or (iii) providing computer-implemented services using the temporary updated deployment until the additional hardware components are integrated into the deployment.

The method may end following operation 316.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 00 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
identifying a solution that is requested to be provided using the deployment of data processing systems;
making a determination that the solution is incompatible with the deployment;
based on the determination:
identifying at least one alternative solution for the solution based on an isometric subgraph analysis of the solution with respect to a plurality of alternative solutions;
obtaining user input indicating agreement or disagreement with use of the at least one alternative solution;
in a first instance of the obtaining where the user input indicates agreement:
updating operation of the deployment based on the at least one alternative solution to obtain an updated deployment; and
providing computer-implemented services using the updated deployment.

2. The method of claim 1, wherein identifying the solution comprises:
obtaining a request for the solution from a user device operated by a user.

3. The method of claim 2, wherein making the determination comprises:
obtaining, based on the request, requirements for the solution, the requirements specifying capabilities of the deployment for the solution to be compatible with the deployment;
identifying available computing components of the deployment, the available computing components being available hardware or software components of the deployment capable of performing actions to facilitate the request; and
making a comparison between the requirements for the solution and the available computing components of the deployment to identify whether the solution is compatible with the deployment.

4. The method of claim 3, wherein making the comparison comprises:
identifying, based on the requirements for the solution, a minimum amount of computing components necessary to perform the solution; and
identifying whether the available computing components meets or exceeds the minimum amount of computing components:
in a first instance of the identifying where the available computing components does not meet or exceed the minimum amount of computing components:
determining the solution is incompatible with the deployment.

5. The method of claim 1, wherein identifying the at least one alternative solution comprises:
building a first graph of the solution;
obtaining a second graph of the at least one alternative solution of the plurality of alternative solutions;
performing the isometric subgraph analysis, using the first graph and the second graph, to obtain at least one quantification of at least one similarity between the solution and the at least one alternative solution;
obtaining a rank order for the at least alternative solution based on the at least one quantification of the at least one similarity;
selecting an alternative solution of the at least one alternative solution based at least in part on the rank ordering; and
providing the selected alternative solution to the user.

6. The method of claim 5, wherein the first graph comprises:
a plurality of nodes interconnected by edges, each node of the plurality of nodes being associated with a corresponding data processing system of the solution, each node comprising characteristics of the corresponding data processing system required by the solution, and the edges relating to required interactions between different data processing systems.

7. The method of claim 5, wherein the second graph comprises:
a plurality of nodes interconnected by edges, each node of the plurality of nodes being associated with a corresponding data processing system of the at least one alternative solution, each node comprising characteristics of the corresponding data processing system required by the at least one alternative solution, and the edges relating to required interactions between different data processing systems.

8. The method of claim 7, wherein performing the isometric subgraph analysis comprises:
computing a similarity score for the second graph with respect to the first graph using an isometric subgraph analysis algorithm, the similarity score quantifying similarity between a structure of the second graph and a structure of the first graph; and
obtaining, using the similarity score for each node, the at least one quantification of the at least one similarity between the solution and the at least one alternative solution.

9. The method of claim 1, wherein obtaining the user input comprises:
providing a notification of the at least one alternative solution to the user device; and
obtaining a response from the user device, the response indicating whether the user agrees with the least one alternative solution to be performed by the deployment.

10. The method of claim 1, further comprises:
in a second instance of the obtaining where the user input indicates disagreement:
providing additional alternative solutions to the user to select at least one of the additional alternative solutions; or
providing an option to add additional hardware components to the deployment to make the deployment compatible with the solution or another solution not presented to the user previously.

11. The method of claim 10, wherein providing the additional alternative solutions to the user comprises:
rank ordering the additional alternative solutions based on the at least one quantification of the at least one similarity to obtain rank ordered additional alternative solutions; and
providing the rank ordered additional alternative solutions to the user for selection of at least one of the additional alternative solutions.

12. The method of claim 10, further comprises:
in an instance of the providing where the option to add the additional hardware components is agreed to by the user:
obtaining user input indicating agreement with temporary use of the at least one of the additional alternative solutions pending integration of the additional hardware components into the deployment;
updating operation of the deployment based on the at least one of the additional alternative solutions to obtain a temporary updated deployment; and
providing computer-implemented services using the temporary updated deployment until the additional hardware components are integrated into the deployment.

13. A non-transitory machine-readable medium having instructions stored therein, which when executed by a processor, cause the processor to perform operations for managing operation of a deployment, the operations comprising:
identifying a solution that is requested to be provided using the deployment of data processing systems;
making a determination that the solution is incompatible with the deployment;
based on the determination:
identifying at least one alternative solution for the solution based on an isometric subgraph analysis of the solution with respect to a plurality of alternative solutions;
obtaining user input indicating agreement or disagreement with use of the at least one alternative solution;
in a first instance of the obtaining where the user input indicates agreement:
updating operation of the deployment based on the at least one alternative solution to obtain an updated deployment; and
providing computer-implemented services using the updated deployment.

14. The non-transitory machine-readable medium of claim 13, wherein identifying the solution comprises:
obtaining a request for the solution from a user device operated by a user.

15. The non-transitory machine-readable medium of claim 14, wherein making the determination comprises:
obtaining, based on the request, requirements for the solution, the requirements specifying capabilities of the deployment for the solution to be compatible with the deployment;
identifying available computing components of the deployment, the available computing components being available hardware or software components of the deployment capable of performing actions to facilitate the request; and
making a comparison between the requirements for the solution and the available computing components of the deployment to identify whether the solution is compatible with the deployment.

16. The non-transitory machine-readable medium of claim 15, wherein making the comparison comprises:
identifying, based on the requirements for the solution, a minimum amount of computing components necessary to perform the solution; and
identifying whether the available computing components meets or exceeds the minimum amount of computing components:
in a first instance of the identifying where the available computing components does not meet or exceed the minimum amount of computing components:
determining the solution is incompatible with the deployment.

17. The non-transitory machine-readable medium of claim 13, wherein identifying the at least one alternative solution comprises:
building a first graph of the solution;
obtaining a second graph of the at least one alternative solution of the plurality of alternative solutions;
performing the isometric subgraph analysis, using the first graph and the second graph, to obtain at least one quantification of at least one similarity between the solution and the at least one alternative solution;
obtaining a rank order for the at least alternative solution based on the at least one quantification of the at least one similarity;
selecting an alternative solution of the at least one alternative solution based at least in part on the rank ordering; and
providing the selected alternative solution to the user.

18. A data processing system, comprising:
a processor; and
a memory coupled to the processor to store instructions, which when executed by the processor, cause the processor to perform operations for managing operation of a deployment, the operations comprising:
identifying a solution that is requested to be provided using the deployment of data processing systems;
making a determination that the solution is incompatible with the deployment;
based on the determination:
identifying at least one alternative solution for the solution based on an isometric subgraph analysis of the solution with respect to a plurality of alternative solutions;
obtaining user input indicating agreement or disagreement with use of the at least one alternative solution;
in a first instance of the obtaining where the user input indicates agreement:
updating operation of the deployment based on the at least one alternative solution to obtain an updated deployment; and
providing computer-implemented services using the updated deployment.

19. The data processing system of claim 18, wherein identifying the solution comprises:
obtaining a request for the solution from a user device operated by a user.

20. The data processing system of claim 19, wherein making the determination comprises:
obtaining, based on the request, requirements for the solution, the requirements specifying capabilities of the deployment for the solution to be compatible with the deployment;
identifying available computing components of the deployment, the available computing components being available hardware or software components of the deployment capable of performing actions to facilitate the request; and
making a comparison between the requirements for the solution and the available computing components of the deployment to identify whether the solution is compatible with the deployment.
